(19) United States
(12) Patent Application Publication
(10) Pub. No.: US 2012/0297248 A1
(43) Pub. Date: Nov. 22, 2012

(54) BLOCK WRITE HANDLING AFTER CORRUPTION

(76) Inventor: Alan David Bennett, Edinburgh (GB)

(21) Appl. No.: 13/109,709

(22) Filed: May 17, 2011

(51) Int. Cl. G06F 12/00; G06F 11/14

(52) U.S. Cl. 714/16; 711/154; 711/E12.001; 714/E11.113

(57) ABSTRACT

A memory device recognizes that data corruption is present in a block. In response, rather than skip the block and continue write operations into a different uncorrupted block, the memory device continues to write data into the corrupted block. The memory device may write data on the basis of logical groups. The logical groups may be smaller than a block and larger than a page, but other sizes are also possible. In response to write corruption in the block (e.g., from power loss during a write operation), the memory device may skip certain parts of the block and continue writing into the block. For example, the memory device may skip the remainder of the page range in which the logical group was going to be written when data corruption occurred, and instead write that logical group into the block from the start of the next logical group unit, the next available page, or any other boundary.

### BACKGROUND OF THE INVENTION

1. Technical Field

This disclosure relates to write handling in memory devices. In particular, this disclosure relates to how a memory device (such as a flash memory device) handles writing data into a block after data in that block has been corrupted.

2. Related Art

Continual development and rapid improvement in semiconductor manufacturing techniques have led to extremely high density memory devices. The memory devices are available in a wide range of types, speeds, and functionality. Memory devices often take the forms, as examples, of flash memory cards and flash memory drives. Today, capacities for memory devices have reached 64 gigabytes or more for portable memory devices such as Universal Serial Bus (USB) flash drives, and one terabyte or more for solid state disk drives. Memory devices form a critical part of the data storage subsystem for digital cameras, digital media players, home computers, and an entire range of other host devices.

Many memory devices group the host data by logical address. The memory device may then write the host data for a single logical group together in sequential order. Commonly, a logical group is the same size as the size of a block (i.e., the smallest erasable unit in the memory device), and the block spans multiple pages (i.e., the smallest writable unit in the memory device). If the memory device loses power during a write operation, the power loss may lead to corrupted data in one or more pages in the block. The memory device cannot use these pages until they are erased. As a result, it may be impossible to write the logical group completely into the same block without performing a costly erase operation. Alternatively, to complete the write operation for the logical group, the memory device must copy the good data already written to the block to another uncorrupted block, then write the remaining data for the logical group into the uncorrupted block. Accordingly, in the past, write corruption was the source of significant inefficiencies in the operation of a memory device.

### SUMMARY

A memory device recognizes that data corruption is present in a block. In response, rather than skip the block and continue write operations into a different uncorrupted block, the memory device continues to write data into the corrupted block. The memory device may skip selected parts of the block and continue writing into the block at selected locations. In other words, when a write operation of specified data results in corrupted data in the block, the memory device may nevertheless continue to write data into the block. The subsequently written data may be any desired data, including the same data for which the prior write operation failed (thereby completing the failed write operation in a different area in the same block where the corrupted data exists), or different data (e.g., additional data written to the block that has been received from a host or other data source).

Other features and advantages will become apparent upon examination of the following figures, detailed description, and claims.

### BRIEF DESCRIPTION OF THE DRAWINGS

The system may be better understood with reference to the following drawings and description. In the figures, like reference numerals designate corresponding parts throughout the different views.

FIG. 1 shows a fully programmed block that stores a logical group extending over sixteen (16) pages.

FIG. 2 shows a prior technique for handling data corruption in a block.

FIG. 3 shows a memory device.

FIG. 4 shows a technique for handling write operations to a block in which corrupted data exists.

FIG. 5 shows alternate techniques for handling write operations to a block in which corrupted data exists.

FIG. 6 shows logic that a memory controller may execute to handle write operations to a block in which corrupted data exists.

FIG. 7 shows a technique for handling subsequent write operations to a block including multiple level cells in which corrupted data exists.

FIG. 8 shows logic that a memory controller may execute to handle write operations to a block including multiple level cells in which corrupted data exists.

### DETAILED DESCRIPTION OF THE PREFERRED EMBODIMENTS

The discussion below makes reference to host devices and memory devices. A host device may be a wired or wireless device, may be portable or relatively stationary, and may run from DC (e.g., battery power), AC power, or another power source. A host device may be a consumer electronic device such as a personal computer, a mobile phone handset, a game device, a personal digital assistant (PDA), an email/text messaging device, a digital camera, a digital media/content player, a GPS navigation device, a satellite signal (e.g., television signal) receiver, or cable signal (e.g., television signal) receiver. In some cases, a host device accepts or interfaces to a memory device that includes the power converter. Examples of memory devices include memory cards, flash drives, and solid state disk drives. For example, a music/video player may accept a memory card that incorporates the power converter described below, or a personal computer may interface to a solid state disk drive that includes the power converter below. The power converter may be used in other devices, including in the host device itself.

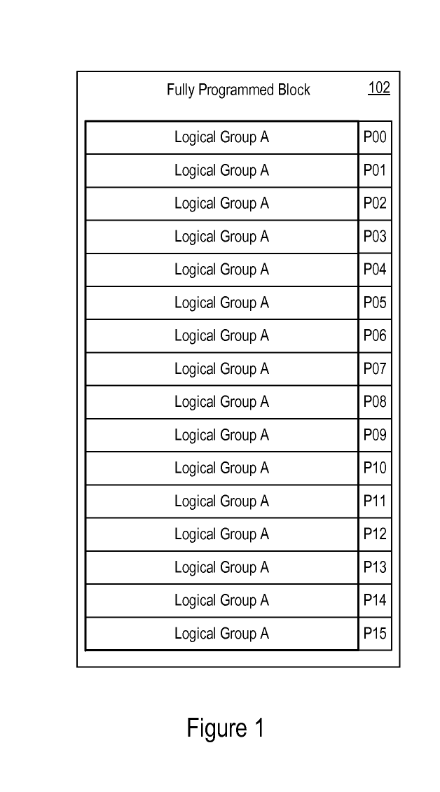

FIG. 1 shows a fully programmed block 102 that stores a logical group 104 extending over sixteen (16) pages P00-P15. In this instance, the logical group A is the same size as the block 102. Blocks, pages, and logical groups may vary widely in size.

Blocks represent minimum erasable units in a non-volatile memory device. In other words, an erase operation cannot erase anything less than an entire block of data. Pages in the blocks represent minimum read/writeable units in the blocks. In other words, a memory device cannot read or write any smaller unit than one page of data from or to the memory array. Blocks are typically much larger than pages.

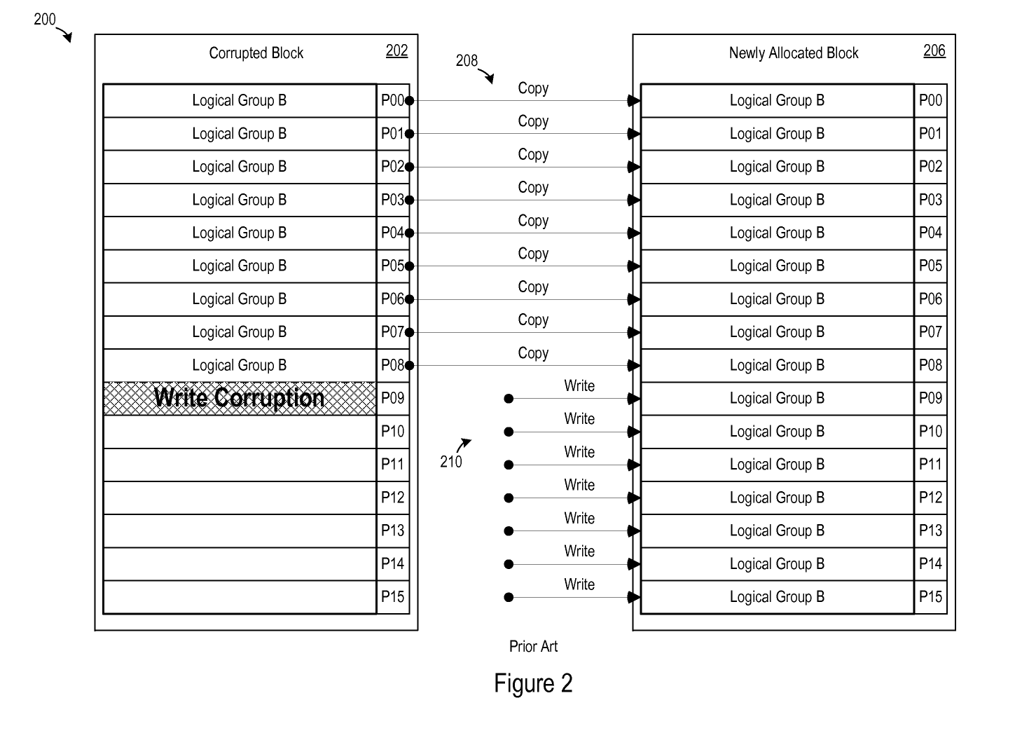

FIG. 2 shows a prior technique 200 for handling data corruption in a corrupted block 202. In particular, FIG. 2 shows a scenario in which the memory device began to write the logical group B into a new block. During the write of page P09, write corruption occurred. The write corruption may have occurred, for example, due to power failure during the write operation. As a result, the logical group B was not fully written to the block 202.

The memory device may detect corruption by reading pages to determine whether they hold valid data. In the prior technique, when the block includes data corruption, no further writes are made to the corrupted block 202. Instead, the memory device allocates a new block 206 from a free block list and the memory device copies the uncorrupted data for the logical group B to the new block 206 using the copy operations 208. In addition, the memory device uses the write operations 210 to complete the remaining data for the logical group B in the new block 206. The result is that the new block 206 is fully programmed with the logical group B. The memory device then releases the corrupted block 202 back to the free block list from which the memory device may select blocks for erasure and reuse.

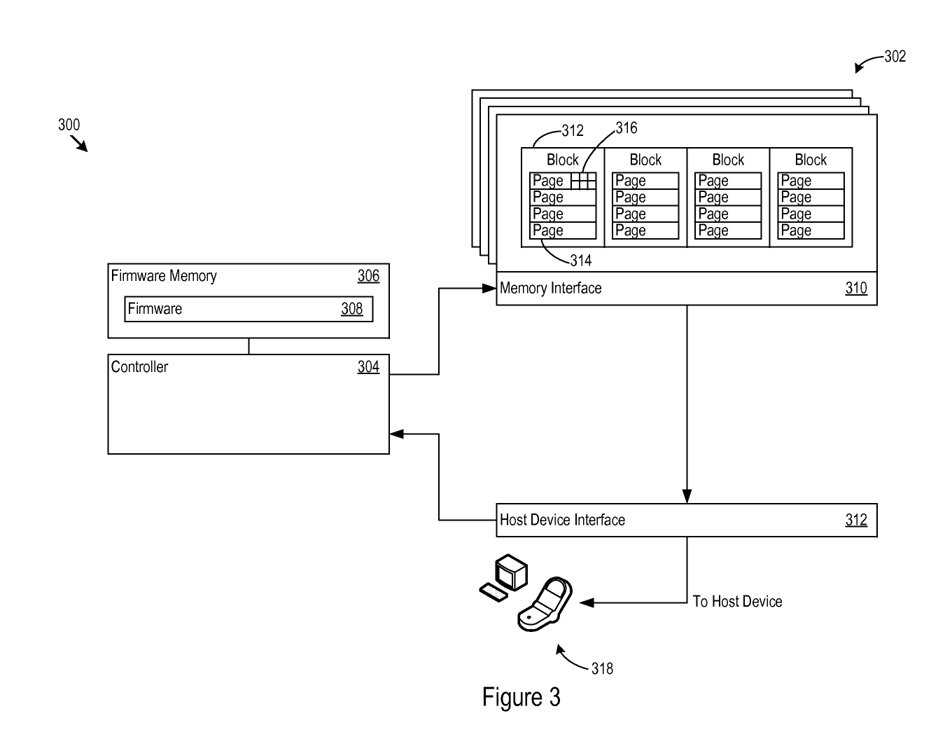

FIG. 3 shows a memory device 300 that handles writes operations to blocks with corrupted data in a different manner. The memory device includes a memory array 302, a controller 304 and a firmware memory 306. The firmware memory 306 may store firmware 308 for execution by the controller 304. The controller 304 and firmware 308 handle read/write operations to the memory array 302 through the memory interface 310 as described in more detail below. The memory interface 310 may include, as examples, address decoders (e.g., row and column decoders), voltage control circuitry, sense circuitry, and other memory interface circuitry for reading, writing, and erasing data in the memory array 302.

The memory array 302 may include one or more dies of memory distributed across one or more memory packages. The memory device 300 may organize the memory array 302 into blocks (e.g., the block 312) of pages (e.g., the page 314) that extend over a predetermined number memory cells 316. The memory cells may be single level cells (SLCs) or multiple level cells (MLCs). Furthermore, the memory device 300 may read or write data into the blocks on the basis of logical groups, each of which may be one or more pages in size. As examples, blocks may be 2, 4, or 8 MBytes in size, pages may be 8 or 16 KBytes in size, and logical groups may be 8 or 16 pages in size. However, each of these sizes may vary widely to meet the design requirements for any particular desired implementation. In some implementations, a logical group may be smaller than a page, or larger than a block.

The memory device 300 may perform read, write, and erase operations on the basis of metablocks and metapages. Metablocks may be formed as a collection of multiple blocks across multiple dies or packages (e.g., an aggregation of 4 2 MB blocks over 4 dies). Similarly, metapages may be formed as a collection of multiple pages across the metablock (e.g., 4 pages, one in each block forming a metablock). A logical metagroup may be an integer multiple (e.g., 8 or 16) of metapages. A block or metablock may be the minimum erasable unit in the memory array 302, and a page or metapage may be the minimum readable/writeable unit in the memory array 302.

A host device interface 312 provides communication between the memory device 300 and the host devices 318. As examples, the host device interface 312 may be a Secure Digital (SD), micro SD, Compact Flash, or another flash memory card interface. The host devices 318 send host data to the memory device 300 for storage in the memory array 302, and issue read requests for the memory device 300 to return previously stored data. The memory device 300 handles write operations of specified data into the blocks in the presence of corrupted data as described in more detail below.

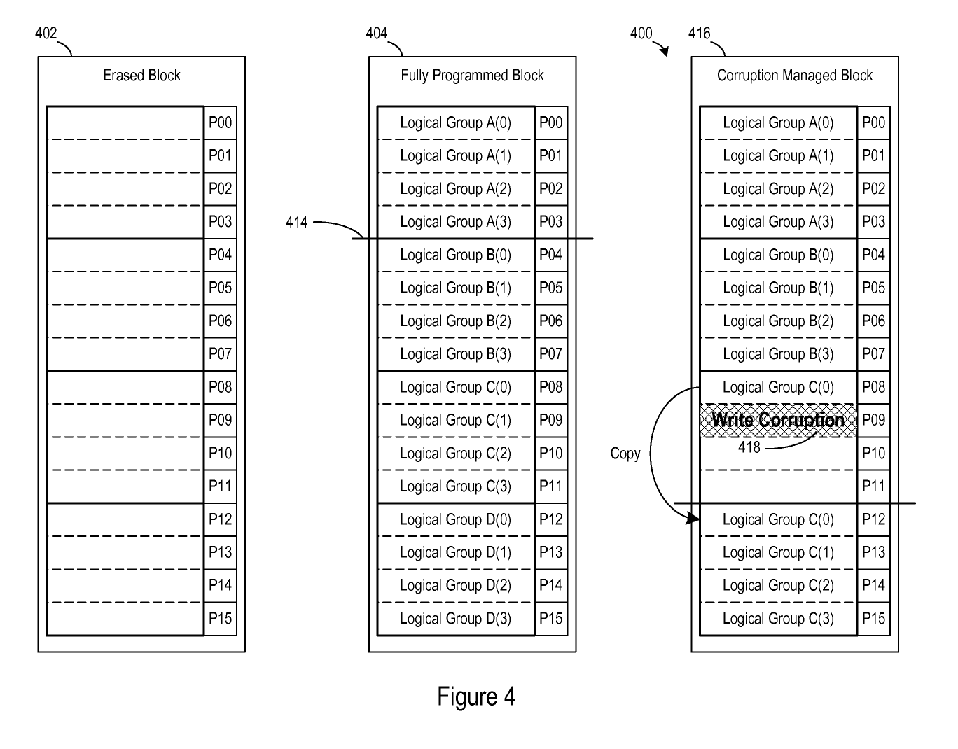

FIG. 4 shows a technique 400 implemented in the firmware 308 for handling write operations to a block in which corrupted data exists. For this example, the erased block 402 illustrates a block structure extending over 16 pages P00-P15. The erased block 402 is ready to accept logical groups of data (e.g., host data) that the controller 304 will write into the erased block 402. For this example, each logical group extends over four pages and therefore four logical groups fill a block. The logical group size may vary, however, and it is not required that the logical group size be set such that an integer multiple of logical groups fill a block.

The fully programmed block 404 shows specified data that the memory device 300 organized into four logical groups: logical group A, logical group B, logical group C, and logical group D. Each logical group A-D extends over four consecutive pages forming a logical group unit, and the logical groups A-D completely fill the fully programmed block 404. Each logical group unit begins at a logical group boundary defined in the block. For example, the logical group unit for logical group B is aligned starting on the logical group boundary 414, and extends over the next four consecutive pages. A logical group boundary may occur at page P00 and every ‘n’ pages thereafter, where ‘n’ is the number of consecutive pages over which the logical group extends. More generally, however, the controller 304 may write a logical group to a logical group unit aligned at a logical group boundary located at any page.

FIG. 4 also shows the corruption managed block 416 and how the controller 304 handles writes when corrupted data exists. In this example, the controller 304 has successfully written the logical group A and the logical group B into the corruption managed block 416. However, during the write of the logical group C, write corruption 418 occurred at page P09. Note that the first page of data P08 for logical group C was correctly written. The write corruption may have occurred as a result, for example, of power loss during the write operation.

When the memory device 300 resumes operation (e.g., when power is restored), the controller 304 determines that page P09 is corrupt. For example, the controller 304 may determine whether data patterns in or around the last written page exhibit the characteristics of corruption. One way that this may be done is for the controller 304 to search for pages with data with errors that are uncorrectable by the error correcting coding associated with the data. The controller 304 may execute the search upon resumption of operation from power failure, or at any other time. Alternatively, the controller 304 may receive a message or signal indicative of whether a write failure has occurred. Such a message or signal may be sent by other control logic in the memory device responsible for writing data to the non-volatile memory 302 and checking for correctness of the written data. The controller 304 may employ any other known techniques for determining write corruption.

Despite the presence of data corruption 418 in the corruption managed block 416, there are still six uncorrupted pages (P10-P15) that could hold another full logical group of data. The controller 304 recognizes that there is enough uncorrupted data space in the corruption managed block 416 for another logical group unit of data. Accordingly, the memory device 300 continues to write data into the corruption managed block 416, as opposed to copying data to a newly allocated block and releasing the corruption managed block 416 for erasure and reuse.

In particular, the controller 304 may take the specified data that formed the initial attempt at writing logical group C, and write that data as subsequent data in another location in the corruption managed block 416. Furthermore, as long as the corruption managed block 416 has sufficient room for additional logical groups, the controller 304 may continue to receive subsequent data, organize it into additional logical groups, and write the additional subsequent data into the block. The data may be data received from a host device 318, data generated by the memory device 300, data from any other source, or any combination of such data. As examples, the write operations may occur in response to data storage requests from the host devices 318 or as part of garbage collection operations by the memory device 300.

In the example shown in FIG. 4, the controller 304 copies the correctly written specified data (at page P08) for the logical group C to the start of the next logical group boundary at page P12. The controller 304 then finishes the write of logical group C by writing the remaining three pages of specified data for the logical group C into consecutive pages P13, P14, and P15 to complete the logical group unit. The controller 304 need not read and copy data that was previously successfully written, but may instead obtain the four pages of data for logical group C from a buffer, by requesting the data again from the host device 318, or in other ways.

The controller 304 may continue to write logical groups of additional specified data (e.g., received from the host devices 318) into a block with data corruption as long as the block has sufficient space to hold the subsequent logical groups. For example, if the corruption managed block 416 were 32 pages (P00-P31) in size, then the controller may rewrite logical group C into pages P12-P15, and write four subsequent logical groups (each 4 pages in size) into pages P16-P31.

One advantage of continuing to write into a block with data corruption is that the memory device 300 may handle write corruption without the need to allocate in every instance an extra block. Other advantages are that handling the data corruption in this way requires less copying and that correctly written logical groups may remain in their original locations, eliminating the need to update logical group directory structures. These advantages give rise to physical endurance and performance benefits for the memory array 302.

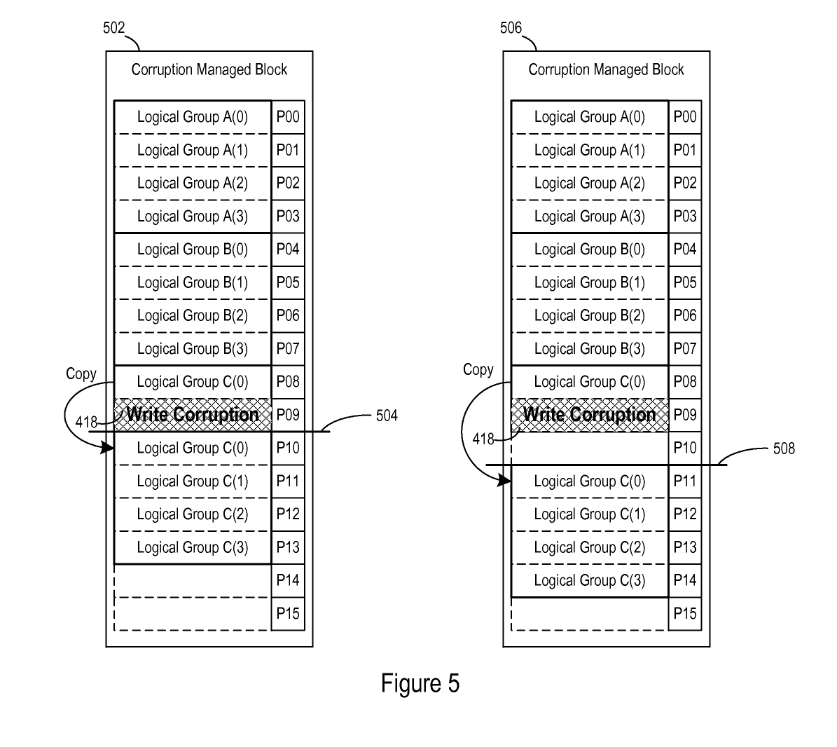

FIG. 5 shows additional examples of writing logical groups into blocks in which corrupted data exists. In the corruption managed block 502, the controller 304 has successfully written specified data organized as logical group A and logical group B into the block. Write corruption occurred at page P09 during the write of logical group C. Nevertheless, the controller 304 continues to use the corruption managed block 502, rewriting the logical group C starting at page P10 and skipping the corrupted data 418 at page P09. More specifically, the controller 304 wrote logical group C as a logical group unit of four consecutive pages to pages P10, P11, P12, and P13. In doing so, the controller 304 copied the previously successfully written data from logical group C at page P08 to P10, then finished writing the remaining three pages of logical group C into successive pages. The logical group unit for logical group C is aligned on the logical group boundary 504 at the beginning of page P10, and extends over four consecutive pages P10-P13.

In the corruption managed block 506, the controller 304 has successfully written specified data organized as logical group A and logical group B into the block. Write corruption occurred at page P09 during the write of logical group C. With the corrupted data still present, the controller 304 wrote the logical group C into the corruption managed block 506, skipping the corrupted data 418 at page P09. More specifically, the controller 304 wrote logical group C as a logical group unit of four consecutive pages P11, P12, P13, and P14. In doing so, the controller 304 copied the previously successfully written data from logical group C at page P08 to P11, then finished writing the remaining three pages of logical group C into successive pages. The logical group unit for logical group C is aligned on the logical group boundary 508 starting at page P11, and extends over four consecutive pages P11-P14.

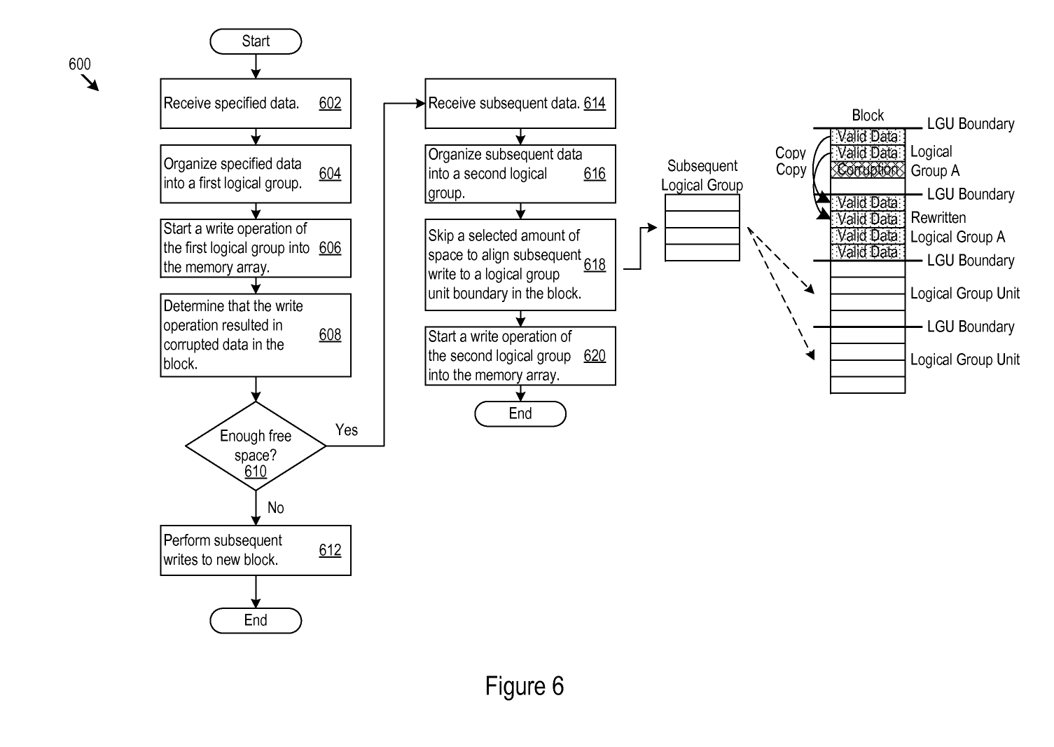

FIG. 6 shows an example of logic 600 that the firmware 308 may implement and that the controller 304 may execute. The firmware 308 causes the memory device 300 to receive specified data (602). The firmware 308 organizes the specified data into a first logical group (604) which may be smaller than a block and larger than a page. The firmware 308 starts a write operation of the first logical group into a block in the memory array 302 (606).

The firmware 308 determines that the write operation resulted in corrupted data in the block (608). Nevertheless, the firmware 308 determines whether there is still enough free space in the write corrupted block to hold another logical group unit of data (610). If there is not sufficient room, then the firmware 308 may allocate a new block and make subsequent writes to the newly allocated block (612).

On the other hand, when the write corrupted block still has sufficient room for one or more logical groups of data, the firmware 308 may continue to write data into the corrupted block. In particular, the firmware 308 may receive or obtain subsequent data (614) and organize it into a second logical group (616). The firmware 308 may skip unused space (e.g., one or more pages) to align the subsequent write to a logical group unit boundary in the block (618) and write the subsequent data into the block while the corrupted data exists in the block (620). In this regard, it is noted that the subsequent data may be entirely new data from the hosts 318, or may be a rewrite of a previously incompletely written logical group (e.g., the logical group C that experienced write corruption at P09 in the examples shown in FIGS. 4 and 5). Furthermore, when the logical group unit is smaller than a page, the logical group unit boundary may be within a page, and there may be multiple such boundaries within the page.

The firmware 308 may skip any pages that hold corrupted data to align the subsequent write to the next available uncorrupted page. Alternatively, the firmware 308 may skip ahead in terms of units of logical group size to the next logical group unit boundary in the block. As one example, with a bock of 16 pages and logical groups of 4 pages, the logical group unit boundaries may be located at the start of pages 0, 4, 8, and 12.

The memory array 302 may use single level cells (SLCs) or multiple level cells (MLCs). MLCs may store, for example, one of four different charge levels to represent the bit patterns 00, 01, 10, or 11. Any individual MLC is typically connected to a single word line, and the MLC may conceptually be divided into two pages, an upper page and a lower page. In other words, the four charge levels electrically define in the physical structure of a single MLC two pages that each encode one bit, and each bit may be considered to be present in a lower page or an upper page. The lower page and upper page typically span multiple memory cells sharing a common word line. Typically, the less significant bit of the two bits is considered to be stored in the lower page, while the more significant bit of the two bits is considered to be stored in the upper page.

In one implementation of the MLCs, a bit pattern of 11 corresponds to an unprogrammed state of the memory cell. The memory device 300 may apply programming pulses to the memory cell to program a page bit of the lower page. The charge level increases and then represents, for example, the bit pattern 10, corresponding to a programmed state of the page bit of the lower page.

For a page bit of an upper page, when the page bit of the lower page is programmed (a bit pattern of 10), the memory device 300 may apply programming pulses to the memory cell to increase the level of charge to a level that corresponds to a bit pattern of 00. However, if the page bit of the lower page is not programmed (a bit pattern of 11), the memory device may applying programming pulses to the memory cell to increase the level of charge to a level that represents the bit pattern 01, corresponding to a programmed state of the page bit of the upper page.

The memory device 300 may apply different types of page sequencing to program the MLCs. As one example, the memory device 300 may employ Lower-Middle (LM) page sequencing. Different implementations of LM page sequencing may be employed. In some implementations, LM page sequencing writes pages in sequential order (e.g., page 0, page 1, page 2, page 3 . . . ), and the memory organization is such that adjacent pages map to different word lines.

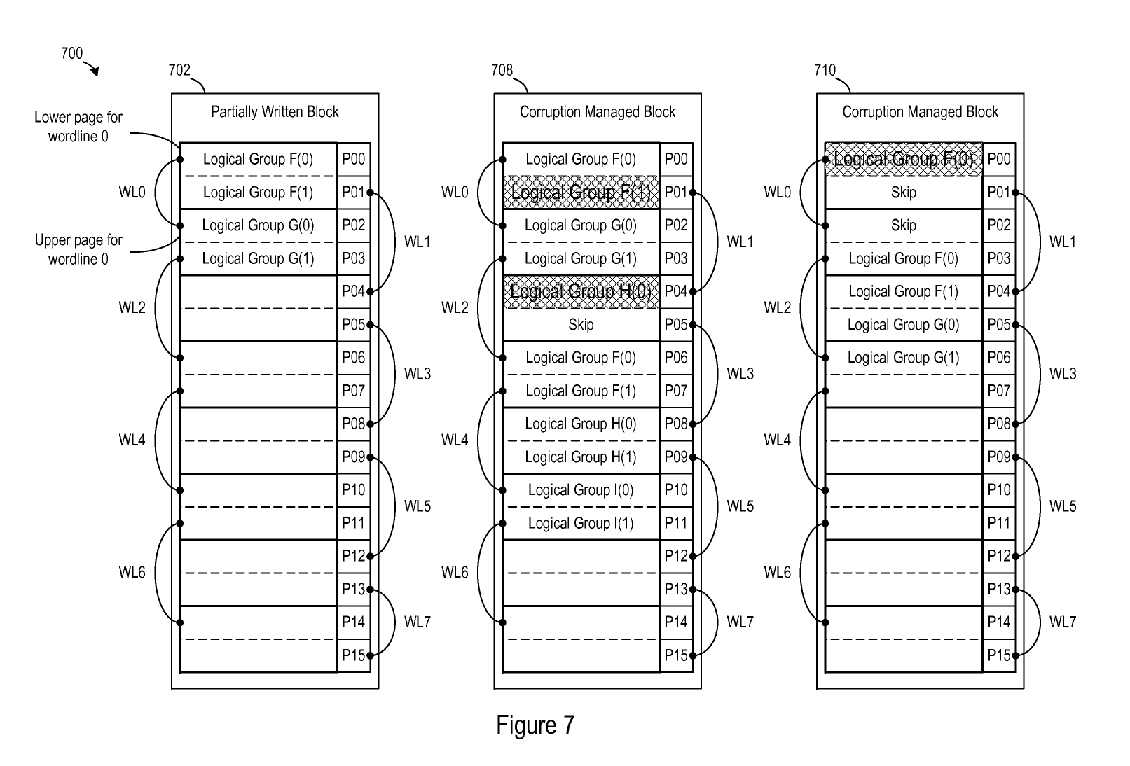

FIG. 7 shows a technique 700 for handling subsequent write operations to a block including MLCs in which corrupted data exists. For the example shown in FIG. 7, the blocks are organized into 16 pages P00-P15 of MLCs, each of which may store four different charge levels to encode two bits of information into a conceptual lower page and conceptual lower page. The logical group size is two pages in this example.

FIG. 7 also shows the assignment of word lines (WL) to the MLCs. For example, WL0 is connected to the physical MLCs that are conceptually divided into the lower page P00 and the corresponding upper page P02. As another example, WL1 is connected to the physical MLCs that are conceptually divided into the lower page P01 and the corresponding upper page P04.

FIG. 7 shows a partially written block 702 after the controller 304 has successfully written logical group F and logical group G. The logical group F resides on the lower page of WL0 and the lower page of WL1. The logical group G resides on the upper page of WL0 and the lower page of WL2.

FIG. 7 also shows a corruption managed block 708. In this example, the controller 304 began to write the first page of logical group H on the upper page of WL1 (page P04), however write corruption resulted. The second page of logical group H would have been written to the lower page of WL3 (page P05), but when the controller 304 determined that the first page was corrupt, the controller 304 stopped the write operation for logical group H, leaving page P05 empty. The controller 304 therefore effective skips page P05 and handles the write corruption as noted below.

The write corruption affects both the successfully written data in the lower page of WL1 (part of the data for logical group F) as well as the data on the upper page of WL1 (where part of the data for logical group H was being written). That is, the MLCs for P01 and P04 define upper and lower pages which together store the previously successfully written specified data and the corrupted data. When operation resumes after the write corruption, the controller 304 determines that MLCs include corrupted data. In particular, the controller 304 identifies that corrupted data exists for logical group F and for logical group H. In response, the controller 304 copies the previously written specified data that was successfully written into P01 for logical group F to an available writable unit in the corruption managed block 708 (while the corrupted data exists in the corruption managed block 708). In the example of FIG. 7, the controller 304 copies the successfully written specified data in P01 into P07 as part of a write operation that restores the integrity of logical group F as a new logical group unit extending over P06 and P07 in the corruption managed block 708. Similarly, the controller 304 writes the logical group H into a new logical group unit extending over P08 and P09.

In the context of MLCs, the next available writeable unit may be an area of memory that does not share the same wordline as an area of memory that holds corrupted data. In other words, the controller 304 may skip ahead in the physical domain to reach an available writeable unit that is on a different wordline than the memory area that holds the corrupted data.

Even with the rewrite operations of logical group F and logical group H, the corruption managed block 708 is not full. Thus, the controller 304 may continue to write additional logical groups of data into the corruption managed block 708. FIG. 7 shows one example in which the controller 304 receives subsequent data, organizes it into logical group 1712, and writes it into a next available logical group unit (pages P10 and P11) in the corruption managed block 708.

In the example above, write corruption occurred when writing the upper page of WL1 (page P04). Note, however, that corruption may also occur when writing a lower page (e.g., page P00 on WL0 or page P01 on WL1). The controller 304 proceeds in a similar manner when write corruption happens in a lower page. More specifically, the controller 304 may skip any particular uncorrupted location in a corruption managed block and continue writing data. As one specific example, the controller 304 may skip the upper page corresponding to the lower page where write corruption exists. As another example, the controller 304 may skip ahead to a subsequent logical group boundary (e.g., the next logical group boundary).

With reference again to FIG. 7, the corruption managed block 710 shows an example in which write corruption occurred during the write of the first page of logical group F to page P00, the lower page on WL0. The second page of logical group F would have been written to the lower page of WL1 (page P01), but when the controller 304 determined that the first page was corrupt, the controller 304 stopped the write operation for logical group F, leaving page P01 empty. The controller 304 therefore effective skips page P01. The controller 304 also skips page P02 because it is the upper page of the corrupted lower page P00. In the example shown in FIG. 7, the controller 304 tries to write logical group F to an uncorrupted part of the corruption managed block 710 at pages P03 and P04. Additional writes may occur elsewhere in the corruption managed block 710. When upper page data is written to a cell in which the lower page was skipped (e.g., page P08 in the corruption managed block 708 or page PO4 in the corruption managed block 710), the controller may treat the lower page data as a ‘0’, a ‘1’, or as undefined. Furthermore, in other implementations, the controller 304 may avoid writing to upper pages for which there is no lower page data. Instead, the controller 304 may skip pages, for example, skipping page P04 and rewriting logical group F in the corruption managed block 710 to pages P03 and P05, and writing subsequent data to consecutive pages (e.g., to restart LM sequence writing), such as by writing logical group G to pages P06 and P07).

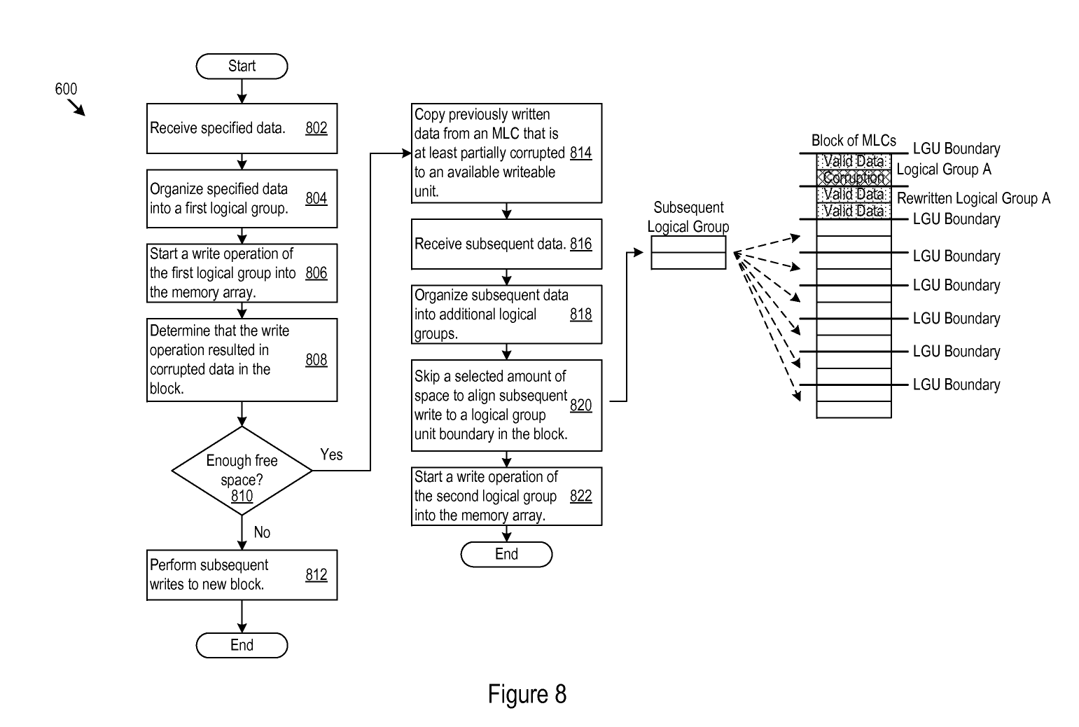

FIG. 8 shows logic 800 that the firmware 308 may implement and that the memory controller 304 may execute to handle write operations to a block including multiple level cells in which corrupted data exists. The memory device 300 receives specified data (802). The firmware 308 organizes the specified data into a first logical group (804) which may be smaller than a block and larger than a page. The firmware 308 starts a write operation of the first logical group into a block in the memory array 302 (806).

The firmware 308 determines that the write operation resulted in corrupted data in the block (808). Nevertheless, the firmware 308 determines whether there is still enough free space in the write corrupted block to hold another logical group unit of data (810). If there is not sufficient room, then the firmware 308 may allocate a new block and make subsequent writes to the newly allocated block (812).

Because the memory array uses MLCs, the write corruption may extend over multiple previously written logical groups of specified data. Therefore, when the write corrupted block still has sufficient room for one or more logical groups of data, then the firmware 308 skips one or more corrupted pages, and copies the previously written specified data that is now corrupted or that may potentially be corrupted to an available writable unit (814) in the block (while the corrupted data exists in the block) starting at any logical unit boundary for free space in the block. Returning, to the example in FIG. 7, the controller 304 rewrites logical group F and logical group H (both of which are supported by common MLCs into which corrupted data was written) into different logical group units in the memory array 302.

As long as the corruption managed block has sufficient room, the controller 304 may continue to write additional logical groups into the memory array 302. Accordingly, the controller 304 may receive or obtain subsequent data (816) and organize it into additional logical groups (818). The firmware 308 may skip one or more pages to align the subsequent write to a logical group unit boundary in the block (820) and writes the subsequent data into the block while the corrupted data exists in the block (822).

The firmware 308 may skip any pages that hold corrupted data to align any subsequent write to the next available uncorrupted page. Alternatively, the firmware 308 may skip ahead in terms of units of logical group size to the next logical group unit boundary. As one example, with a bock of 16 pages and logical groups of 2 pages, the logical group unit boundaries may be located at the start of pages 0, 2 4, 6, 8, 10, and 12.

The methods, controller 304, firmware 308, and other logic described above may be implemented in many different ways in many different combinations of hardware, software or both hardware and software. For example, all or parts of the controller 304 may include circuitry in a controller, a microprocessor, or an application specific integrated circuit (ASIC), or may be implemented with discrete logic or components, or a combination of other types of circuitry. All or part of the logic may be implemented as instructions for execution by a processor, controller, or other processing device and may be stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method of writing data to a memory device, the method comprising:
starting a write of specified data to a block in a memory device, the block corresponding to a minimum erasable unit in the memory device;
determining that the write resulted in corrupted data in the block; and
writing subsequent data into the block while the corrupted data exists in the block.

2. The method of claim 1, where writing subsequent data comprises making another attempt to write the specified data.

3. The method of claim 1, further comprising:
organizing the specified data into a logical group for the write of the specified data, the logical group smaller in size than the block.

4. The method of claim 3, where:
the block comprises pages, each of which is a minimum writeable unit in the memory device; and
the logical group is larger than the pages.

5. The method of claim 1, where writing subsequent data comprises:
staring the write of the subsequent data to an available page in the block.

6. The method of claim 1, where writing subsequent data comprises:
starting the write of the subsequent data to an available logical group unit defined in the block and extending over multiple pages in the block.

7. The method of claim 1, where writing the subsequent data further comprises:
skipping over a selected amount of unused space in the block to align the subsequent write to a logical group unit boundary defined in the block.

8. The method of claim 1, where:
the block comprises pages of multiple level cells, each multiple level cell storing multiple data bits and where each page is a minimum writeable unit in the memory device.

9. The method of claim 8, further comprising:
copying previously written data, successfully written to the multiple level cells, to an available writable unit in the block while the corrupted data exists in the block.

10. The method of claim 9, further comprising:
organizing the specified data and subsequent data into logical groups smaller in size than the block and larger than the pages, and where:
starting the write comprises: starting the write of a first logical group comprising the specified data; and
writing the subsequent data comprises: writing a second logical group comprising the subsequent data.

11. The method of claim 9, where the multiple level cells hold an upper page and a lower page which together store the previously written data and at least a portion of the corrupted data.

12. A memory device comprising:
a non-volatile memory; and
a controller in communication with the non-volatile memory; and
firmware that when executed by the controller causes the controller to:
start a write of specified data to a block in the non-volatile memory, the block corresponding to a minimum erasable unit in the memory device;
determine that the write resulted in corrupted data in the block; and
write subsequent data into the block while the corrupted data exists in the block.

13. The memory device of claim 12, where the write of the subsequent data comprises another attempt to write the specified data.

14. The memory device of claim 12, where the firmware further causes the controller to:
organize the specified data into a logical group for the write of the specified data, the logical group smaller in size than the block.

15. The memory device of claim 14, where:
the block comprises pages, each of which is a minimum writeable unit in the memory device; and
the logical group is larger than the pages.

16. The memory device of claim 12, where the write of the subsequent data comprises:
a write of the subsequent data to an available page in the block.

17. The memory device of claim 12, where:
the firmware causes the controller to write the subsequent data to an available logical group unit defined in the block and extending over multiple pages in the block.

18. The memory device of claim 12, where:
the firmware causes the controller to skip over a selected amount of unused space in the block to align the subsequent write to a logical group unit boundary in the block.

19. The memory device of claim 12, where:
the block comprises pages of multiple level cells, each multiple level cell storing multiple data bits and where each page is a minimum writeable unit in the memory device.

20. The memory device of claim 19, where the firmware further causes the controller to:
copy previously written data, successfully written to the multiple level cells, to an available writable unit in the block while the corrupted data exists in the block.

21. The memory device of claim 20, where the firmware further causes the controller to:
organize the specified data and subsequent data into logical groups smaller in size than the block and larger than the pages;
start the write with a first logical group comprising the specified data; and
write the subsequent data in a second logical group comprising the subsequent data.

22. The memory device of claim 20, where the multiple level cells hold an upper page and a lower page which together store the previously written data and at least a portion of the corrupted data.

23. A memory device comprising:
a non-volatile memory organized as:
blocks that represent minimum erasable units in the memory device; and
pages in the blocks that represent minimum writeable units in the blocks;
a controller in communication with the non-volatile memory; and
firmware that when executed by the controller causes the controller to:
organize specified data into a first logical group;
write the first logical group into the non-volatile memory aligned on a first logical group boundary within a selected block among the blocks;
determine that the write resulted in corrupted data in the selected block;
organize subsequent data into a second logical group; and
write the second logical group into the non-volatile memory while the corrupted data exists in the selected block, the second logical group aligned on a second logical group boundary within the selected block, where:
each logical groups is smaller than the blocks and larger than pages.

24. The memory device of claim 23, where the firmware further causes the controller to:
skip over an uncorrupted page among the pages for the write of the second logical group.

25. The memory device of claim 23, where:
the blocks comprise multiple level cells, each multiple level cell storing multiple data bits.

26. The memory device of claim 25, where the firmware further causes the controller to:
copy previously written data, successfully written to the multiple level cells, to an available writable unit in the block while the corrupted data exists in the block.
